(19) United States
(12) Patent Application Publication
(10) Pub. No.: US 2008/0298059 A1
(43) Pub. Date: Dec. 4, 2008

(54) Led Lamp System

(75) Inventors: Josef Andreas Schug, Wurselen (DE); Joseph Ludovicus Antonius Maria Sormani, Knegsel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,042

(22) PCT Filed: Aug. 2, 2005
(86) PCT No.: PCT/IB05/52585

§ 371 Date: Feb. 1, 2007

(30) Foreign Application Priority Data
Aug. 6, 2004 (EP) 04103785.4

(51) Int. Cl. F21S 2/00; H01J 1/62

(52) U.S. Cl. 362/240; 313/503

(57) ABSTRACT

The invention relates to an LED lamp system comprising at least one LED element (4) for emission of light, a chamber (1) with inner sidewall faces (2), which are designed to be at least partially highly reflective, with a light entrance face (3) for the emitted light and with an exit opening (6) for the light radiated into the chamber (1) and reflected from the inner side wall faces (2), and a collimator (7), which is arranged at the exit opening (6) of the chamber (1) and which has an outcoupling opening (9) facing said exit opening.

The invention relates to an LED lamp system comprising at least one LED for emission of light as well as to an LED lamp array with a plurality of such LED lamp systems.

In recent years, the technology with respect to design and manufacture of inorganic solid LEDs has improved rapidly, up to a stage of development at which inorganic white light emitting LEDs can be manufactured whose efficiency is higher than 40 lm/Watt. This efficiency distinctly exceeds that of traditional white incandescent lamps (16 lm/Watt) and of most Halogen lamps (30-35 lm/Watt). The efficiency of a single LED element has grown in the meanwhile to much higher than 100 lm/Watt.

A problem which both now and in the future will affect the wide usability of LEDs for illumination purposes is the still relatively limited quantity of light per LED element. An increase in performance can be achieved for such LED lamp systems only if the quantity of light can be combined for a plurality of LED elements. Though this is possible in principle, it still presents problems if a light source with particularly high brightness is required, e.g. because the emitted light must be focused in a reflector of small dimensions.

To generate white light using an LED, use is made of, inter alia, so-termed phosphor coated LEDs (PC-LED). Such a phosphor-coated LED is an LED which has a phosphor coating over its radiation surface. Phosphor is not to be understood specifically as the chemical element, but rather more generally as a fluorescent material which, under the effect of light radiation of a certain wavelength, emits light of another wavelength. There are fluorescent materials which radiate yellow light on irradiation by blue light. In agreement with the color of the emitted light, they are called yellow phosphor. By using such LEDs, white light is obtained by applying a yellow phosphor layer to an LED radiating blue light. Said phosphor layer is to be dimensioned such that a part of the blue light from the LED passes through the phosphor layer unhindered and another part of the phosphor layer is converted into yellow light. The simultaneous radiation of blue and yellow light is perceived as white light by the user. Alternatively, there are LED elements which radiate UV light and are coated with a white phosphor layer. By a suitable selection of the type and thickness of the phosphor layer, PC LEDs can be manufactured that radiate also other colors.

A light source device, comprising a light-guide block in the form of a hollow body with reflective inner walls and a matrix-like arrangement of point light sources such as LED elements, is known from U.S. Pat. No. 6,547,400 B1. A major portion of the light beams radiated by the point light sources is introduced into the guide block and collimated there. A considerable part of the light beams radiated by the point light sources is, however, not collected by the light guide block. This reduces the light output of the device considerably.

U.S. Pat. No. 6,402,347 describes a device, in which individual LED elements are arranged on a common plate and each element is provided with a collimating attachment. Fresnel lenses connected to each respective LED element allow the radiation beam from each individual LED to be introduced into a common secondary optical system. The disadvantage of this system is the high losses, amounting to about 60%, caused by reflection at the different optical interfaces.

It is an object of the invention, therefore, to provide a device by means of which the light output per LED can be raised.

This object is achieved by a proposed LED lamp system that has at least one LED element for emission of light, a chamber and a collimator. It is assumed hereinbelow that the LEDs are inorganic solid bodies, because such LEDs with sufficient intensity are presently available. That notwithstanding, they can of course also be other electro-luminescent elements, e.g. laser diodes or other light emitting semiconductor elements or organic LEDs, so long as they have sufficiently high performance values. The term LED or LED element is therefore to be understood in this document as a synonym for every kind of corresponding electro-luminescent elements. The light can be IR or UV light, apart from the visible light.

The chamber of the LED lamp system according to the invention comprises inner side wall faces that are designed to be at least partially highly reflective, a light entrance face for the light emitted by the LED element into the chamber and an exit opening for the light radiated into the chamber and possibly reflected by the inner side wall faces. The collimator is arranged at the exit opening of the chamber and has an outcoupling opening facing said exit opening. The light radiated by the LED element is radiated in a diffused form into the chamber at the entrance opening. The invention thus follows the principle of capturing the light radiated by the LED element as completely as possible and introducing it in collimated form into the collimator, in order to couple the radiation into secondary optics in a properly directed manner by using the collimator. The chamber is thus used to capture the diffusely radiated light and to emit it at the exit opening substantially without loss. The exit opening of the chamber will therefore generally be placed facing the light entrance face so that a large portion of the emitted light can be radiated out of the chamber directly and without reflection.

The light entrance face of the chamber may be formed by a light emission surface, be it the exit face of the LED element or a layer of a fluorescent material, which is excited by light emission from an LED. According to an advantageous embodiment of the invention, the light entrance face of the chamber is formed by the radiation surface of an LED element. The light emitted by the LED element is thus coupled into the chamber directly and without losses. Obviously, the light entrance face of the chamber may also be formed by the radiation surfaces of a plurality of LED elements arranged next to each other.

Alternatively, it can also be advantageous however if the light entrance face of the chamber is spatially separated from an LED radiation surface. This is especially advantageous if a fluorescent material must be provided for generating a certain light color. Then the fluorescent material can form the light entrance face that is irradiated from its rear side facing away from the chamber by at least one LED element.

The light impression of the LED element depends on the layer thickness and the uniformity of the applied fluorescent material. The more uniform the required layer thickness of the fluorescent material, the more homogeneous will be the effect of the light emitted by the LED element. Another advantageous embodiment of the invention proposes that a carrier comprising a fluorescent material provided on and/or in it and/or a wavelength filter, especially a dichroic filter, be placed in the space between the light entrance face of the chamber and the LED radiation surface. The provision of the fluorescent material on a carrier makes the manufacture of LEDs independent of the application of the fluorescent material or decouples the LED element manufacturing process from coating with a fluorescent material. The fluorescent material can be applied more uniformly on a separate carrier and with greater accuracy in terms of layer thickness. This is favorable for the light impression of the LED element. In addition, the carrier with the fluorescent material can be arranged at any desired location in the chamber. This can be somewhere between the LED radiation surface and the radiation opening of the chamber.

If the light, for example blue light, radiated by an LED element enters the layer of fluorescent material and is converted to yellow light there, then it is radiated from said layer also like Lambert radiation in a non-directional, scattered manner. It is not possible to avoid yellow light from also being radiated against the desired radiation direction of the LED lamp system back into the direction of the LED element where it is subsequently absorbed. This causes losses in light output. It is therefore advantageous if a wavelength filter, preferably a dichroic filter, is arranged between the LED radiation surface and the fluorescent material. For example, this filter is permeable to radiated blue light from the LED element, but not to yellow light. Now, if blue light emerges from the LED element and enters the phosphor layer and meets a body of fluorescent material, which converts it to yellow light and reflects it in the direction of the LED element, then, before being absorbed there, it is reflected once more by the wavelength filter and exits through the radiation opening of the chamber after penetrating the layer of fluorescent material. This prevents blue radiation already converted into yellow light from being already absorbed within the chamber and thus being lost as light. Advantageously, the wavelength filter can simultaneously be used as a carrier, on which the fluorescent material is provided. This makes it possible to achieve a very compact design for the chamber.

Collimator and chamber can in principle have any shapes and dimensions, as long as they help towards achieving a high light output from the radiation emitted by the LED. Said high light output is achieved by collimating the radiation directly at the entrance opening into the chamber, after which it is emitted as high luminance radiation at the exit opening. In an advantageous embodiment of the invention, the light entrance face is therefore designed to be larger than the exit opening of the chamber. This size ratio between the light entrance face and the exit opening of the chamber helps achieve a high luminance, because almost the entire luminous power of the entrance opening is re-emitted in concentrated form at the smaller area of the exit opening.

The chamber serves to generate as high a luminance as possible at its exit opening. To this end, on the one hand, none of the light radiated from the light entrance face should be lost e.g. due to absorption, and on the other, the light should also not be reflected too often, because each reflection also entails loss in light output. According to an advantageous embodiment of the invention, the inner sidewall faces are therefore arranged so as to be inclined towards the light entrance face. Experiments have shown that a maximum light output is achieved at an inclination of the inner side wall faces of about 30°. The inclination allows the radiated light to be reflected back to the light entrance face and to be emitted from there through the exit opening by at least a partial further reflection. The light in the chamber can thus be subjected to multiple reflections before leaving the chamber. This concept therefore requires a high reflectivity of all components of the chamber.

Loss of light output of an LED element can be caused in the LED element itself, if the generated light cannot leave the LED body in the first place, because it is totally reflected at the body edges of the LED element due to the unfavorable index of refraction from thick material to thin material. It would therefore be advantageous to place a predominantly transparent material between the radiation surface and the fluorescent material, which transparent material reduces or adjusts the difference between the refractive index of the LED element and the refractive index of the layer of fluorescent material. Such a so-termed optical cement can be formed from silicone and makes it possible to completely couple out the light generated in the LED element. The edges of the transparent material can be made reflective to increase the efficiency.

In addition, the fluorescent material can be contained or dispersed in the transparent material, which would allow a more compact chamber structure. It is also advantageous if the transparent material fills up the chamber or the collimator, at least partially. The transparent material thus lends more stability to the chamber.

The LED lamp system according to the invention is suitable not only for arrangements in which fluorescent material is excited by radiation from an LED element. Rather, also LED elements that already radiate light in the desired color can be used in the LED lamp system described. To create a more pleasant light impression for the observer, however, it may be desirable that the light radiated from the LED is scattered. A highly transparent non-luminescent powder can therefore be advantageously used, instead of the fluorescent material, to disperse the light emitted by the LED. In the case of LED elements which can do without fluorescent material, e.g. AlInGaP-elements for red or amber colored light or in the case of bare InGaN-LED-elements, the highly transparent, non-luminescent powder, such as TiO₂, provides the scatter effect of the—in this case—superfluous fluorescent substance and hence a more homogenous light impression.

According to another advantageous embodiment of the invention, multiple LED lamp systems are arranged next to one another in an LED lamp array. They can be arranged in a row, i.e. one-dimensionally, or two-dimensionally, such that their arrangement forms a matrix or honeycomb pattern. This can be done in such a manner that a certain lighting pattern is achieved. An arrangement can be selected for that purpose, in which all outcoupling openings of the collimators are focused on a common point e.g. the coupling opening of a lens. For this purpose, either the longitudinal axes of the collimators can be configured so as to be inclined with respect to a normal to the light entrance face of the associated chambers, or a plurality of LED lamp systems can be arranged next to each other in such a manner that their light entrance faces, or at least their outcoupling openings, form a curved surface.

There are also mechanical advantages to be derived from a matrix or honeycomb pattern arrangement of a plurality of lamp systems next to each other. For example, it is advantageous that several LED lamp systems have a common continuous carrier for fluorescent material and/or wavelength filters. This not only simplifies the design and manufacture of the LED lamp array, but also leads to greater stability.

According to another advantageous embodiment of the invention, the LED elements of several lamp systems are arrayed on such a common base plate. This enables, for example, a more rational use of electrical connections for the energy supply to the LED elements, a more economical arrangement of cooling elements that have to ensure dissipation of the heat generated during operation of the LEDs and also an increase of the stability of the LED lamp array.

Another advantageous embodiment of the invention involves the size ratio of the outcoupling openings and light entrance faces. Accordingly, it can be advantageous to configure the surface of the outcoupling openings so as to be larger or smaller by a specific factor than the light entrance faces. If the outcoupling opening is greater than the light entrance face, then it would be possible to compensate for a greater distance between the LED elements, which can become required if the heat load per area on the common base plate could become too high in a periodic arrangement of juxtaposed LED elements. An outcoupling opening smaller than the light entrance face can be advantageous for display applications. The distance between the outcoupling openings is un-illuminated and appears to the observer as a black frame around the outcoupling opening. By this fragmentation of the exit openings of each LED lamp system, it is possible to create visible rasterization of the display.

According to another advantageous embodiment of the invention, LED elements with various wavelength characteristics are used in various LED lamp systems. This allows the creation of certain color impressions in a lamp array, e.g. white light through combination of red, blue and green LED elements. Alternatively, different color impressions can be created within a lamp array if each of the individual LED lamp systems has individual colors. This could be needed in display applications. On the other hand, a smooth transition between two or more colors can also be generated within a lamp array, e.g. a transition from blue to yellow.

The lamp array according to the invention can be used advantageously also in automotive applications. For instance in the headlamp area, at least individual LED lamp systems of a LED lamp array can have IR radiation-emitting LED elements, for example for supporting night vision devices.

These and other aspects of the invention are apparent from and will be elucidated, by way of non-limitative example, with reference to the embodiment(s) described hereinafter. In the drawings,

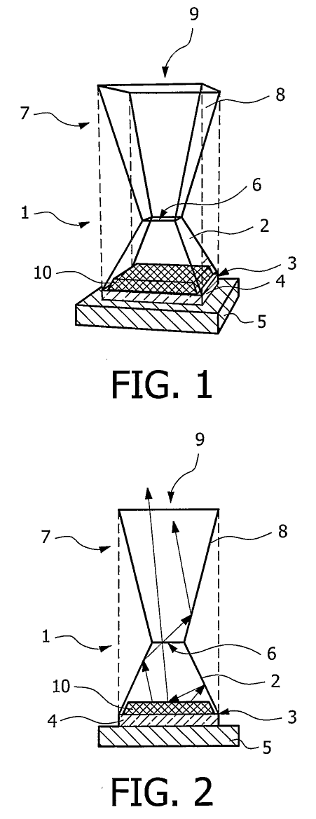

FIG. 1 is a perspective view of a lamp system according to the invention,

FIG. 2 is a sectional view of a lamp system shown in FIG. 1,

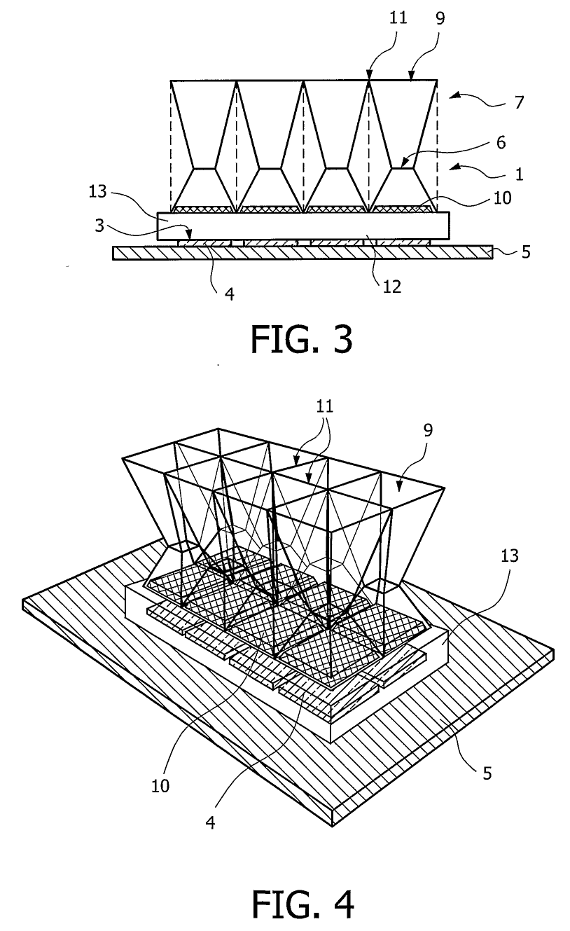

FIG. 3 is a sectional view through a grouping of lamp systems,

FIG. 4 is a perspective view of a grouping as shown in FIG. 3,

FIG. 1 shows a lamp system in accordance with the invention, which is formed, for example, by a chamber-collimator combination comprising a chamber 1 with four highly reflective sidewalls 2, which are at an angle with respect to a base surface. The base surface is formed by the radiation surface 3 of an LED element 4, which is arranged on a base plate 5. The radiation surface 3 represents the light entrance face of the chamber 1. An upper boundary surface of the chamber 1 forms a radiation opening 6 facing the radiation surface 3. Consequently, the chamber 1 has the shape of a truncated pyramid. The radiation opening 6 is in turn the base surface of a collimator 7, which also has the shape of a truncated pyramid but placed inverted: Its four highly reflective side walls 8 flare upwards to an outcoupling opening 9, which has dimensions corresponding to those of the radiation surface 3. The chamber-collimator combination is thus formed from two different truncated pyramids set one on top of the other and can be inscribed in a cuboid (shown in broken lines). The larger length of its rectangular side faces corresponds to the total of the heights of the chamber 1 and the collimator 7, and the dimensions of its square end faces are those of the radiation surface 3 or of the outcoupling opening 9.

A fluorescent layer 10 is applied on the radiation surface 3 of the LED element 4. Since the radiation surface forms the base area 3 of the chamber 1, the fluorescent layer 10 is already inside the chamber 1.

FIG. 2 shows the interaction of chamber 1 and collimator 7. The radiation emitted by LED element 4 penetrates through the fluorescent layer 10 and is radiated non-directionally into the chamber 1 by said fluorescent layer. Due to said non-directional radiation of the light from the LED elements 4, radiation from an LED element 4 can be radiated not only into the chamber 1 assigned to it, but quite possibly also into the neighboring chamber 1. In the chamber 1, it is radiated either directly through the radiation opening 6 into the collimator 7 or reflected by the reflecting sidewalls 2 and the fluorescent layer 10 till it leaves the chamber 1 through the radiation opening 6. As the radiation opening 6 is smaller than the radiation surface 3 of the LED element 4, which radiation opening must however pass the entire luminous power emitted at the radiation surface 3, there is a higher luminance at the radiation opening 6 than at the radiation surface 3 of the LED element 4. At the same time, the light issuing from the radiation opening 6 is much more directed than that emitted from the radiation surface 3. The scatter losses of the chamber-collimator combination are therefore very low.

The inventive chamber-collimator combination per se is not restricted to the shape and dimensions depicted in FIGS. 1 and 2. But it is particularly advantageous if a number of chamber-collimator combinations are grouped together. Chamber-collimator combinations forming such a group can be arranged in a matrix-like manner as shown in FIGS. 3 and 4, without dead space and with highly efficient space utilization on contact lines 11. A pre-requisite for this is that the dimensions of the radiating surface 3 and outcoupling opening 9 correspond to one another.

A plurality of LED-elements 4 are arrayed on a base plate 5, which, apart from accommodating the LED elements 4, also is responsible for the dissipation of the heat developed during operation of the LED elements. For considerations relating to the heat performance installed per unit area on the base plate 5, it can be advisable to array the LED elements 4 with an intermediate distance 12. A carrier 13, extending over all LED elements, is arranged on the radiation surface 3 of the LED elements 4 facing away from the base plate 5. A major thickness, not necessarily reflecting the necessary dimensions of the carrier 13, is shown in FIGS. 3 and 4 to make this clear. The fluorescent layer 10 is applied on said carrier, and hence need no longer be applied on the individual LED elements 4. It can be configured as a continuous layer or, as shown, as individual segments allocated to the LED-Element 4. In addition, a wavelength filter, not shown, can be arranged in or on the carrier 13. The carrier 13 in the FIGS. 3 and 4 is dimensioned such that it can also support the chamber-collimator combination. In addition, the LED elements 4 can be arranged on the side of the carrier 13 facing the chamber-collimator combination.

If, on the other hand, the outcoupling opening 9 has larger dimensions, while the dimensions of the radiation opening 6 and radiation surface 3 remain the same, then there is a greater mutual distance between the LED elements 4.

A different shape of the base surface of these two components, for example a hexagonal one, allows the creation of a honeycomb-like arrangement instead of a matrix arrangement.

Summarizing, it is pointed out once more that these systems and methods, illustrated in the Figures and the description, are only examples of embodiments, which can be modified to a large extent by a person skilled in the art, without leaving the framework of the invention.

Moreover, it is pointed out for the sake of completeness, that the use of the indefinite article “a” or “an” does not exclude the presence of a plurality of the relevant items.

1. LED lamp system comprising
at least one LED element (4) for emission of light,
a chamber (1) with inner side wall faces (2), which are designed to be at least partially highly reflective, with a light entrance face (3) for the emitted light and with an exit opening (6) for the light radiated into the chamber (1) and reflected from the inner side wall faces (2), and
a collimator (7), which is arranged at the exit opening (6) of the chamber (1) and which has an outcoupling opening (9) facing said exit opening.

2. LED lamp system as claimed in claim 1, characterized in that the light entrance face of the chamber (1) is formed by an LED radiation surface (3).

3. LED lamp system as claimed in claim 1, characterized in that the light entrance face of the chamber (1) is distanced from an LED radiation surface.

4. LED lamp system as claimed in claim 3, characterized in that a carrier (13) with a fluorescent substance (10) provided on it and/or in it and/or a wavelength filter is arranged at a distance from the radiation surface (3).

5. LED lamp system as claimed in claim 1, characterized in that the light entrance face (3) is larger than the exit opening (6) of the chamber.

6. LED lamp system as claimed in claim 1, characterized in that the inner side wall faces (2) of the chamber (1) are inclined towards the light entrance face (3).

7. LED lamp array with a plurality of LED lamp systems as claimed in claim 1.

8. LED lamp array as claimed in claim 7, characterized in that a plurality of the LED lamp systems have a common continuous carrier (13).

9. LED lamp array as claimed in claim 7, characterized in that the LED elements (4) for a plurality of LED lamp systems are arranged on a common base plate (5).

10. LED lamp array as claimed in claim 7, characterized in that the area of the outcoupling openings (9) is larger or smaller than the light entrance faces (3).

11. LED lamp array as claimed in claim 7, characterized in that LED elements (4) of various wavelength characteristics are used in various LED lamp systems of the LED lamp array.
